(19) United States
(12) Patent Application Publication
(10) Pub. No.: US 2020/0215856 A1
(43) Pub. Date: Jul. 9, 2020

(54) ADJUSTABLE AIRLESS TIRE SYSTEM WITH SPRINGS

(71) Applicants: Hai Huang, Herndon, VA (US); Tony Huang, Herndon, VA (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 16/823,202

(22) Filed: Mar. 18, 2020

Related U.S. Application Data
(63) Continuation-in-part of application No. 16/137,436, filed on Sep. 20, 2018.
Application No. 16/137,436 is a continuation-in-part of application No. 16/183,681, filed on Nov. 7, 2018.
Application No. 16/183,681 is a continuation-in-part of application No. 16/416,069, filed on May 17, 2019.
Application No. 16/416,069 is a continuation-in-part of application No. 16/752,658, filed on Jan. 26, 2020.

(51) Int. Cl. B60C 7/18

(52) U.S. Cl. CPC B60C 7/18; B60C 2007/146

(57) ABSTRACT

An adjustable airless tire system uses springs, a metallic hawser loop and a control component to regulate a tension and a size of the ground contact surface of the tire, which optimizes contradictory relationship between hardness and suspension of the tire according to changes of road conditions. An enhanced rim of a wheel to protect the springs and provide limited moving ability for the vehicle if the airless system loses their functions; and a curved tire to form a closed space between the tire and the rim to prevent foreign objects from sticking between them. Therefore the invention improves oil efficiency, affordable, comfortability, controllability and safety.

### FIELD OF THE DISCLOSURE

The present disclosure generally relates to the field of an adjustable airless tire system with springs and, more particularly, relates to using the springs to support tires and absorb impact energy; and a metallic hawser loop to transfer shock impulses of a rough road from a ground contact surface of the tire to whole walls of the tire; and a control component to regulate a tension and a size of the ground contact surface of the tire according road conditions, which possess its advantages of oil efficiency, comfortability, controllability and safety.

### BACKGROUND

Current internal inflated tire uses elasticity of whole walls of the tire to provide suspension for a vehicle by transferring shock impulses of a rough road from a ground contact surface of a tire to whole walls of the tire through air within the tire. As the shock impulses compress the ground contact surface of the tire, impact energy will be transferred to whole walls of the tire through the air within the tire, which will expand the walls of the tire. The suspension provided by the walls of the tire absorbs and temporarily stores the impact energy, which reduces impacts on the vehicle. But disadvantage for the internal inflated tire is air leaking if the tire is penetrated by sharp materials.

Nowadays, there are many types of airless tires. But, they just absorb the impact energy from the ground contact surface of the tires, and cannot efficiently transfer the impact energy to whole walls of the tires; they also need special materials that must have enough hardness to support the weight of the vehicle as well as enough elasticity to provide suspension for the vehicle. But there is contradictory relationship between hardness and elasticity, which compromise their functions. Increased hardness of the materials reduces the elasticity, which decreases its suspension potential, and increased elasticity of the materials generates greater ground contact surface of the tires, which increases its rolling resistance and consumes more oil. In addition, their special materials will also be more expensive.

Road conditions may be different, such as a rough road or slippery one, which need different tension and size of the ground contact surface of the tire to keep comfortability, stability and safety during driving. But it is not easy for current tires to adjust the tension and size of the ground contact surface of the tire according changes of the road conditions.

The invention uses springs, a metallic hawser loop and a control component to regulate a tension and a size of the ground contact surface of the tire, which optimizes contradictory relationship between hardness and suspension of the tire according to changes of road conditions. So, the adjustable airless tire system in the invention improves ride quality and vehicle handling, which possess the advantages of oil efficiency, affordable, comfortability, controllability and safety.

### BRIEF SUMMARY OF THE DISCLOSURE

The present disclosure includes an adjustable airless tire system with springs. The springs support weight of a vehicle and absorb impact energy.

A metallic hawser loop transfers the impact energy from the springs of a ground contact surface of the tire to whole springs within the tires to maximize their suspension potential to absorb the impact energy.

A control component will regulate extension of the metallic hawser loop to regulate a tension and a size of the ground contact surface of the tire according road situations, which improve its fuel economy, comfortability, controllability and safety during driving.

An enhanced rim of a wheel keeps an appropriate distance from the tire to protect the springs and provide limited moving ability if the airless tire system is failed.

Utilizing any suitable elastomer and all types of reinforcing materials as similar as current internal inflated tires, the adjustable airless tire is economic and affordable. Its curved shape provides a closed space between the tire and the rim to prevent foreign objects from sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawing is merely an example for illustrative purposes according to various disclosed embodiments and is not intended to limit the scope of the present disclosure.

FIG. 1 is a view schematically showing an adjustable airless tire system with springs related to the present invention.

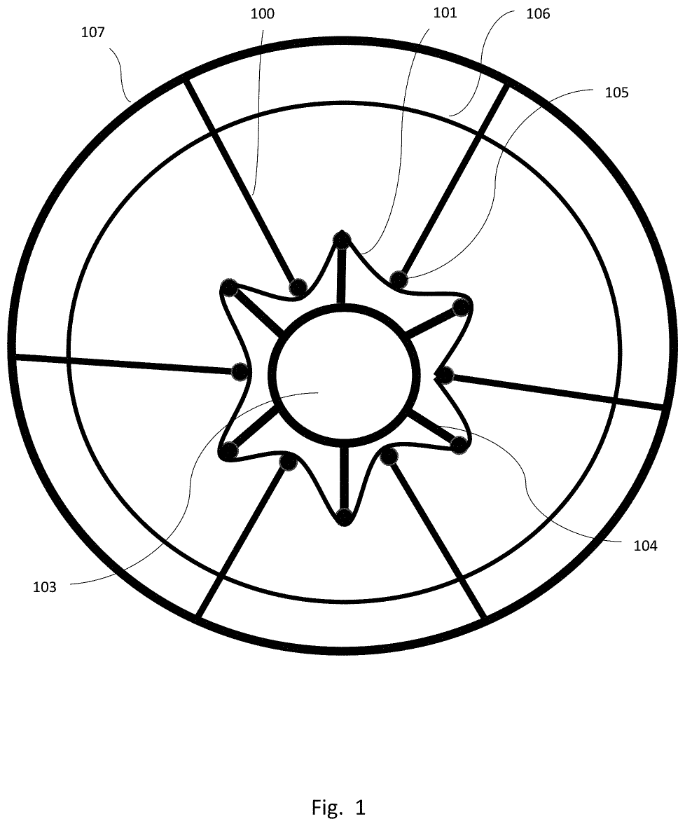

### DETAILED DESCRIPTION

Reference will now be made in detail to exemplary embodiments of the disclosure, which are illustrated in the accompanying drawing. Wherever possible, the same reference numbers will be used throughout the drawing to refer to the same or like parts.

The invention contains appropriate springs 100 to support a weight of a vehicle and provide suspension to absorb impact energy from walls of a tire 107. A plurality of spoke structure of the springs radially extend between a metallic hawser loop 101 and inner walls of the tire. One end of the springs close to the tire is fixed with a shaped plate to fit with the curved inner walls of the tire, and another end of the springs is fixed with a bearing 105 that contact with the metallic hawse to smooth its movement. The springs support the weight of the vehicle, and the spring rates are based on the weight of the vehicle, unloaded and loaded. The springs also provide the suspension to absorb the impact energy, which prevent shacking the vehicle.

The invention contains the metallic hawser loop to transfer the impact energy from the springs of the ground contact surface of the tire to whole springs within the tire to maximize their suspension potential to absorb the impact energy. The metallic hawser loop pushes the springs outward to support whole inner walls of the tire. One function of the metallic hawser is to support the weight of the vehicle coming from the springs. Another function of the metallic hawser is to transfer the impact energy from the springs of the ground contact surface of the tire to whole springs within the tires. As the ground contact surface of the tire compress the corresponding the springs, they will compress a corresponding section of the metallic hawser loop inward. The inward metallic hawser loop will tighten other sections of the metallic hawser loop, which push other springs outward to compress other parts of the walls of the tires. By this way, the impact energy is transferred from the springs of the ground contact surface of the tire to whole the springs within the tire through the metallic hawser, which maximize their suspension potential to absorb the impact energy. Parallelly arranging several metallic hawser loops and the springs will support more parts of the walls of the tire, which will provide more proportionate supports and better suspension for the tire.

The invention contains a control component 103 located at a hub of a wheel to regulate a tension and a size of the ground contact surface of the tire according to road conditions. The control component includes a sensor and control rods. The sensor will detect the tension of the tire to calculate the weight of the vehicle, and will give alert if the tire is overloaded; The sensor also detects a variation of the tension of the tire during driving to judge road condition. An increased variation of the tension of the tire during driving suggests rougher condition of the road. The control rods 104 support the weight of the vehicle coming from the metallic hawser loop. A bearing is fixed at its one end of the control rods to smooth its movement on the metallic hawser loop. The control component can prolong or contract the control rods to regulate extension of the metallic hawser loop, which regulate the tension and size of the ground contact surface of the tire according the road conditions. As a result, it will improve fuel efficiency, comfortability, controllability and safety during driving. First, driving on an even road, regulating the tension of the tire can optimize the size of the ground contact surface of the tire with the road, which will reduce the rolling resistance to improve fuel efficiency; second, driving on a rough road, reducing the tension of the tire will increase suspension potential of the springs, which creates a softer ride to improve the comfortability; third, driving on a slippery road, such as raining, icy or snowing, decreasing the tension of the tire will increase the size of the ground contact surface of the tire with the road, which improves the controllability and safety of the vehicle during driving; fourth, driving on sand or mud terrain, increasing the size of the ground contact surface of the tire will decrease pressure of the tire on the ground, which reduces sinking of the tire into sand or mud. It also improves traction of the tire over loose ground surface; and fifth, at emergency braking, the increased size of the ground contact surface of the tire will increase frictional resistance between the ground and the tire to decrease braking distance, which may save lives.

The invention contains a rim 106 of the wheel to protect the springs and provide limited moving ability if the airless tire system is failed. The rim of the wheel is properly enhanced and keeps an appropriate distance from the tire to limit the maximal level of inward movement of the springs, and support the weight of the vehicle if the tire is overload or the impact energy is too strong. The rim provides limited moving ability if the airless tire system loses their functions. The rim can also help to locate the springs.

The tire is made of any suitable elastomer with all types of reinforcing materials that is similar as current internal inflated tires to support the weight of the vehicle and enhance its performance. Its cross section of the tire is curved as the internal inflated tires to form a closed space between the tire and the rim with its two sides mounted within the rim flange of the wheel, which prevents foreign objects from sticking between them to improve driving quality and safety.

Other applications, advantages, alternations, modifications, or equivalents to the disclosed embodiments are obvious to those skilled in the art and are intended to be encompassed within the scope of the present disclosure.

What is claimed is:

1. An adjustable airless tire system with springs comprising:
the springs supporting a weight of a vehicle and providing suspension to absorb impact energy;
a metallic hawser loop transferring the impact energy from the springs of a ground contact surface of the tire to whole springs within the tire to maximize their suspension potential to absorb the impact energy;
a control component regulating a tension and a size of the ground contact surface of the tire according to road conditions;
a rim of a wheel keeping an appropriate distance from the tire to protect the springs and provide limited moving ability for the vehicle if the airless tire system is failed; and
the tire forming a closed space between the tire and the rim of the wheel to prevent foreign objects from sticking between them.

2. The adjustable airless tire system according to claim 1, further comprising a plurality of spoke structure of the springs radially extending between the metallic hawser loop and inner walls of the tire, wherein one end of the springs close to the tire is fixed with a shaped plate to fit with the curved inner walls of the tire and another end of the springs is fixed with a bearing to contact with the metallic hawser loop.

3. The adjustable airless tire system according to claim 1, wherein the metallic hawser loop pushes the springs outward to the inner walls of the tire.

4. The adjustable airless tire system according to claim 3, wherein parallelly arranging several metallic hawser loops and the springs will support more sites of the tires to improve their functions.

5. The adjustable airless tire system according to claim 1, wherein the control component further comprises:
a sensor that detects the tension of the tire to calculate the weight of the vehicle and a variation of the tension of the tire during driving to estimate roughness of the road; and
control rods that support the metallic hawser loop and regulate the tension of the tire and the size of the ground contact surface of the tire according to the road conditions by prolonging or contracting the control rods to change the extension of the metallic hawser loop.

6. The adjustable airless tire system according to claim 1, wherein the rim of the wheel keeps an appropriate distance from the tire to limit the maximal level of inward movement of the springs to protect them and support the weight of the vehicle if the tire is overloaded, and the rim of the wheel is properly enhanced to provide limited moving ability for the vehicle if the adjustable airless tire system lose their functions, and the rim also helps to locate the springs.

7. The adjustable airless tire system according to claim 1, wherein the tire is made of suitable elastomer with all types of reinforcing materials, and the cross section of the tire is curved with its two sides of the tire mounted within the rim flange of the wheel to make a closed space between the tire and the rim to prevent foreign objects from sticking between them.
